(19) United States
(12) Patent Application Publication
(10) Pub. No.: US 2016/0178143 A1
(43) Pub. Date: Jun. 23, 2016

(54) METHOD OF FABRICATING A LIGHT EMITTER

(71) Applicant: ARCHIMEJ TECHNOLOGY, Evry (FR)

(72) Inventors: Mejdi NCIRI, PARIS (FR); Eric Christian BELARBRE, BERGERAC (FR)

(21) Appl. No.: 14/910,310

(22) PCT Filed: Aug. 5, 2014
(86) PCT No.: PCT/EP2014/066854

§ 371 Date: Feb. 5, 2016

(30) Foreign Application Priority Data
Aug. 8, 2013 (FR) 1357872

(51) Int. Cl. F21K 99/00; F21V 19/00; F21V 23/00; G01J 3/10

(52) U.S. Cl. CPC F21K 9/90; G01J 3/10; F21V 19/0025; F21V 23/005; F21Y 2101/02; F21Y 2113/005

(57) ABSTRACT

A method of fabricating a light emitter including several sources and a support. Each source is arranged so as to emit a light beam at a working wavelength. For each source, a position of this source along a fixing direction is determined, as a function of optical properties of a spectral multiplexer to be associated with this emitter, of the working wavelength of this source and of a placement of the emitter with respect to the multiplexer. These positions are determined so that, when the emitter is associated with the multiplexer, the multiplexer spatially superimposes the light beams. Next, each source is fixed, along the fixing direction, on the support at its position previously determined, so that the sources are distributed according to the law or properties of chromatic dispersion of the spectral multiplexer. Advantageously, the sources may be fixed on several parallel fixing axes extending along the fixing direction.

### TECHNICAL FIELD

The present invention relates to a method for fabricating a light emitter. It also relates to the emitter obtained by such a method.

The field of the invention is more particularly but non-limitatively that of miniaturized light emitters such as a “multi-chip” emitter with micrometric light-emitting diodes, for applications such as optical spectroscopy or multispectral lighting.

### STATE OF THE PRIOR ART

The concept of a light emitter such as a “multi-chip” LED has existed since the 2000s but is utilized exclusively by the lighting industry.

The challenges facing the lighting industry involve colorimetry and photometry: their aim is to obtain maximum flux, often expressed as lumen, and to optimize the colorimetric rendering in order to obtain white light of the best possible quality, based on the Colorimetric Rendering Index.

The lighting market requires a maximum flux given in lumen. Thus the “multi-chip” emitters existing on the market maximize the density of sources (or “chips”, typically micro LEDs) in the lamp in order to have greater light intensity, and specific collector optics are designed. This is the case in particular of patent US 20120068198 filed by Cree in 2011. The key points of this patent concern the design of the positioning of the sources in order to maximize the density of sources. The design is created so as to optimize the performance and obtain good colorimetric rendering.

In lighting, high-power sources are usually used, thus there are numerous heat problems to be resolved. The design of the supports or the methods is often based on optimization of the heat dissipation. Patent US 20110198628 shows each source directly bonded to the metal base for optimum heat dissipation, the design being created so as to optimize the internal reflections and thus the final flux by using a carefully designed PCB (Printed Circuit Board). Minimization of the distance between the sources in order to have better cover among the sources is also mentioned.

Maximization of the density of sources on the surface of a “multi-chip” emitter is thus an essential feature for a person skilled in the art for these different examples of “multi-chip” emitters.

The purpose of the invention is to propose a method for fabricating a light emitter that is capable of appealing to markets other than that of lighting, in particular scientific markets such as for absorption spectroscopy or fluorescence spectroscopy, lighting for microscopy or for endoscopy, or also communication via visible light (LiFi).

### DISCLOSURE OF THE INVENTION

This objective is achieved with a method for fabricating a light emitter comprising several separate light sources and a support common to all the sources, each source being arranged in order to emit a light beam at a wavelength called working wavelength, characterized in that it comprises:
for each source, determining a position of this source along a fixing direction, as a function of optical properties (typically of chromatic dispersion or preferably of chromatic aberration) of a spectral multiplexer planned to be associated with this emitter, of the working wavelength of this source and of a placement of the emitter with respect to the multiplexer, the spectral multiplexer comprising an optical assembly having chromatic dispersion properties (preferably of chromatic aberration, typically of chromatic aberration of a lens and/or of a prism, preferably of lateral chromatic aberration); the positions of these sources being determined so that, for this placement of the emitter and for these positions of the sources, the optical assembly is arranged in order to bring the light beams of the sources spatially closer together (by means of its properties of chromatic dispersion or preferably of chromatic aberration) so that the multiplexer spatially superimposes said light beams,
fixing each source, along the fixing direction, on the support at its previously determined position.

Each source can be fixed onto the support at its previously determined position so that the sources are distributed along the fixing direction in order of increasing working wavelength. For the fixing step, each source can be fixed onto the support along the fixing direction at its previously determined position, so that all the sources considered as a whole are distributed along the fixing direction in order of increasing working wavelength.

The fixing can comprise fixing sources on at least two parallel fixing axes extending along the fixing direction. Among all the sources, two sources having adjacent positions along the fixing direction are preferably not fixed on the same fixing axis. In the case of several fixing axes:
each source can have a quadrilateral shape, preferably of a square or rhombus; for at least a portion of the sources one after another along the fixing direction, each source preferably has one of the diagonals of its quadrilateral shape aligned on one of the fixing axes; and/or
the sources can be distributed on the different fixing axes so that each fixing axis corresponds to a working wavelength range of the sources distributed on this axis, so that there is no intersection between the working wavelength ranges of the different fixing axes; and/or
for each fixing axis considered individually, it is possible to fix each source of this axis on the support at its previously determined position along the fixing direction, so that the sources of this axis are distributed along the fixing direction in order of increasing working wavelength. In this case, it is possible that all the sources taken as a whole are not distributed along the fixing direction in order of increasing working wavelength.

The optical assembly can comprise an optical system having a lateral chromatic aberration, the positions of the sources corresponding to an off-axis use of the optical system. Alternatively, the optical assembly can comprise a diffraction grating.

Fixing each source can comprise holding the source with a suction tip, and placing the source on the support by means of the suction tip. The support can be covered with glue before placing each source, and each source can be placed on the glue.

The emitter can comprise an electronic controller of the sources, arranged in order to control each source independently of the other sources.

The method according to the invention can comprise, after fixing, associating the emitter with the multiplexer at its placement considered during the determination of the positions of the sources.

Each source is preferably quasi-monochromatic.

Each source can comprise (preferably can consist of) a light-emitting diode.

The support can be integral with an electronic chip equipped with connecting pins arranged in order to fix the chip onto an electronic circuit board.

The optical assembly can comprise a lens and/or a prism and/or a diffraction grating.

According to yet another aspect of the invention, an emitter is proposed obtained by a fabricating method according to the invention, or an emitter plus multiplexer assembly obtained by a fabricating method according to the invention.

A light emitter according to the invention is therefore proposed (preferably an assembly of this emitter plus a multiplexer comprising an optical assembly having chromatic dispersion properties), said emitter comprising several separate light sources and a support common to all the sources, each source being arranged in order to emit a light beam at a wavelength called a working wavelength, each source having a position on the support along a fixing direction (defined as a function of optical properties of the spectral multiplexer, of the working wavelength of this source and of a placement of the emitter with respect to the multiplexer in the case of the emitter+multiplexer assembly, so that the optical assembly is arranged in order to bring the light beams of the sources spatially closer together by means of its chromatic dispersion properties and so that the multiplexer spatially superimposes said light beams).

The sources are preferably distributed along the fixing direction in order of increasing working wavelength. All the sources taken as a whole are preferably distributed along the fixing direction in order of increasing working wavelength.

The sources can be distributed on at least two parallel fixing axes extending along the fixing direction. Among all the sources, two sources having adjacent positions along the fixing direction are preferably not fixed on the same fixing axis. In the case of several fixing axes:
each source can have a quadrilateral shape, preferably of a square or rhombus; for at least a portion of the sources one after another along the fixing direction, each source preferably has one of the diagonals of its quadrilateral shape aligned on one of the fixing axes; and/or
the sources can be distributed on the different fixing axes so that each fixing axis corresponds to a working wavelength range of the sources distributed on this axis, so that there is no intersection between the working wavelength ranges of the different fixing axes; and/or
for each fixing axis considered individually, it is possible to fix each source of this axis on the support at its previously determined position along the fixing direction, so that the sources of this axis are distributed along the fixing direction in order of increasing working wavelength. In this case, it is possible that all the sources taken as a whole are not distributed along the fixing direction in order of increasing working wavelength.

The emitter can comprise an electronic controller of the sources, arranged in order to control each source independently of the other sources.

Each source is preferably quasi-monochromatic.

Each source can comprise (preferably can consist of) a light-emitting diode.

The support can be firmly fixed to an electronic chip equipped with connecting pins arranged in order to fix the chip onto an electronic circuit board.

In the case of the emitter+multiplexer assembly:
the optical assembly can comprise an optical system having a lateral chromatic aberration, the positions of the sources corresponding to an off-axis use of the optical system, and/or
the optical assembly can comprise (or consist of) a lens and/or a prism and/or a diffraction grating.

### DESCRIPTION OF THE FIGURES AND EMBODIMENTS

Other advantages and characteristics of the invention will become apparent on reading the detailed description of embodiments which are in no way limitative, and from the following attached diagrams:

FIG. 1 shows the emission spectra of two light sources used in the embodiments of emitters according to the invention described hereinafter,

FIG. 2 shows an assembly for a first embodiment of a fabricating method according to the invention for fabricating a first embodiment of an emitter according to the invention,

FIG. 3 is a diagrammatic view of the first embodiment of an emitter according to the invention obtained by the method shown in FIG. 2,

FIG. 4 shows diagrammatically a second embodiment of an emitter according to the invention,

FIGS. 5 to 9 show elements taken into account for a second embodiment of a fabricating method according to the invention for fabricating the second embodiment of an emitter according to the invention,

FIG. 10 is a more general view of an emitter 1 according to the invention, and

FIG. 11 shows a support 2 of an emitter 1 according to the invention, and the sources fixed to this support 2,

FIG. 12 shows a variant for a support 2 of an emitter 1 according to the invention, and the sources fixed to this support 2,

FIG. 13 shows another variant for a support 2 of an emitter 1 according to the invention, and the sources fixed to this support 2,

FIG. 14 is a perspective view of a variant of a support 2 of an emitter 1 according to the invention provided with reliefs,

FIGS. 15 and 16 are profile views of a variant for which the support 2 of an emitter 1 according to the invention is inclined, and

FIG. 17 is a bottom view of a support 2 of an emitter 1 according to the invention, and of the sources fixed to this support 2 in the case of chromatic dispersion properties comprising chromatic folding in the plane of the support 2 at the image of an apochromatic objective lens.

As these embodiments are in no way limitative, variants of the invention can be considered in particular comprising only a selection of the characteristics described hereinafter, in isolation from the other characteristics described (even if this selection is isolated within a phrase containing these other characteristics), if this selection of characteristics is sufficient to confer a technical advantage or to differentiate the invention with respect to the state of the art. This selection comprises at least one, preferably functional, characteristic without structural details, or with only a part of the structural details if this part alone is sufficient to confer a technical advantage or to differentiate the invention with respect to the state of the prior art.

An emitter 1 according to the invention such as described hereinafter comprises N different light sources, N being a natural number greater than or equal to 2 (preferably greater than or equal to 3, preferably greater than or equal to 10).

Each light source Sᵢ (with i an integer, i=1 to N) is arranged in order to emit a light beam comprising one or more wavelengths including a wavelength λᵢ called working wavelength.

Each light source emits its working wavelength in the visible spectrum (between 340 nm and 800 nm).

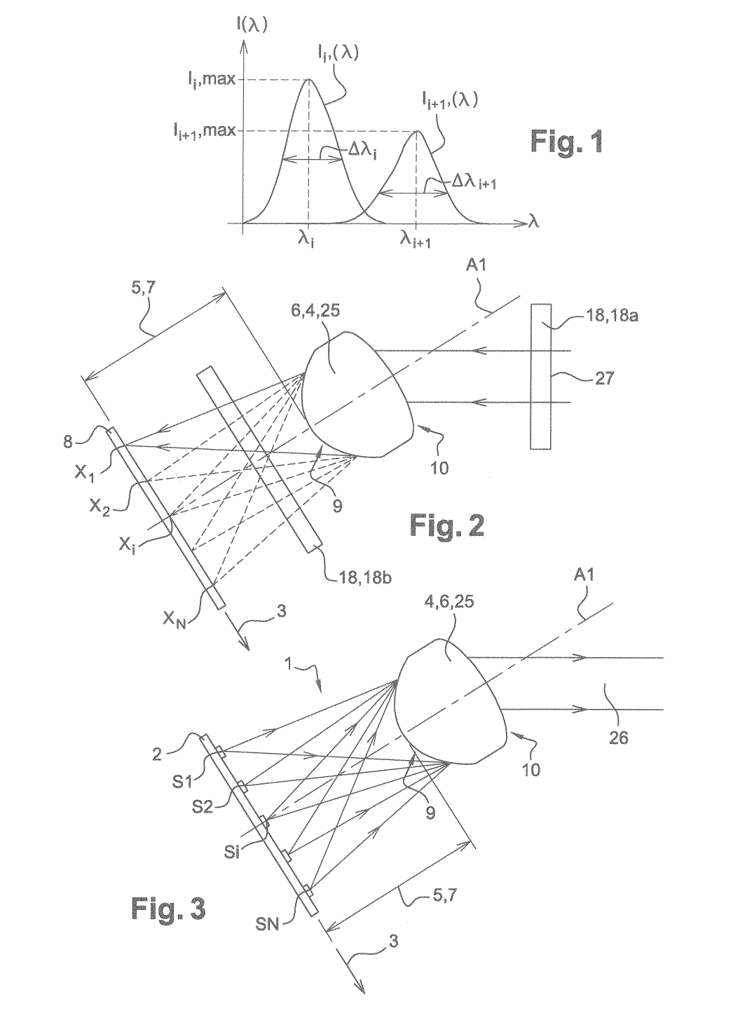

There will be described firstly, with reference to FIG. 1, the emission spectra of each light source Sᵢ used in an emitter 1 according to the invention, (with i an integer, i=1 to N) among the sources S₁ to S_{N} of the emitter.

Reference will be made to the light intensity Iᵢ(λ), respectively Iᵢ₊₁(λ), of two quasi-monochromatic light sources at the wavelengths λᵢ, respectively λᵢ₊₁. Each spectrum Iᵢ(λ), respectively Iᵢ₊₁(λ), has the form of a bell-shaped curve (for example gaussian) having a peak at the wavelength called the working wavelength λᵢ, respectively λᵢ₊₁. This peak has a relatively small full width at half maximum with respect to the working wavelength.

Thus, a first light source Sᵢ has a bell-shaped emission spectrum with:
a peak of height Iᵢ,max (maximum value of the light intensity Iᵢ(λ), i.e. Iᵢ,max (λᵢ)) for the working wavelength λᵢ (for example λ₁=380 nm), and
a full width at half maximum Δλᵢ around the peak at λᵢ, here equal to 10 nm.

Similarly, a second light source Sᵢ₊₁ has a bell-shaped emission spectrum with:
a peak of height Iᵢ₊₁,max (maximum value of the light intensity Iᵢ₊₁(λ), i.e. Iᵢ₊₁,max (λᵢ₊₁)) for the working wavelength λᵢ₊₁ (for example λ₂=410 nm), and
a full width at half maximum Δλᵢ₊₁ around the peak at λᵢ₊₁, here equal to 10 nm.

It can therefore be considered that the light sources Sᵢ and Sᵢ₊₁ are quasi-monochromatic, because:
the full width at half maximum Δλ₁ of the light source Sᵢ is small with respect to the wavelength λᵢ, because Δλᵢ/λᵢ<<1, preferably Δλᵢ/λᵢ<10, preferably Δλᵢ/λᵢ<100 the full width at half maximum Δλᵢ₊₁ of the light source Sᵢ₊₁ is small with respect to the wavelength λᵢ₊₁ car Δλ₊₁/λᵢ₊₁<<1, preferably Aλᵢ₊₁/λᵢ₊₁<10, preferably Δλ₊₁/λᵢ₊₁<100.

Each source has a working wavelength different from the working wavelength of the other sources.

Each source Sᵢ emits its working wavelength λᵢ, at a light intensity Iᵢ(λᵢ) at least ten times (preferably 100 times) greater with respect to the other sources, i.e.: Iᵢ(λᵢ)≧10 Iₖ(λᵢ) with i an integer i=1 to N; and with k an integer k=1 to N but k≠i (preferably Iᵢ(λᵢ)≧100 Iₖ(λᵢ)).

Preferably, the working wavelength of each source is not emitted by the other sources.

Provision can also be made for the use of other polychromatic sources having other shapes of spectrum. According to the invention, as a function of the position of the light source, only a portion of its spectrum centred on a wavelength called a working or emission wavelength will be utilized. A polychromatic source can thus be used, provided that its spectrum has a high intensity at this working wavelength.

Each light source comprises (preferably consists of) a light-emitting diode (LED). The use of light-emitting diodes makes it possible to reduce the risk of failure, as LEDs are light sources that have a longer service life than the light sources usually used in devices such as a spectrometer, like incandescent or discharge sources. Moreover, LEDs have the advantage of being small and low cost.

Each source comprises or is a light-emitting diode of encapsulated type. This means that each individual source comprises in this case at least one light-emitting diode or “LED chip” that emits light and is placed in a housing making it possible on the one hand, to dissipate the heat given off by each chip when it emits (thus ensuring a constant temperature for example using a Pelletier module as is conventionally done), and, on the other hand, to supply electrical power (in particular electric current) to each chip for its operation. The housing is thus generally constituted by a heat-resistant and electrically insulating material such as for example an epoxide polymer such as epoxy resin, or a ceramic.

Thus, each source is designed to operate at a given temperature and at a given electrical current.

Determining each position according to the invention is carried out within this hypothesis of given temperature and of given electrical current, which thus corresponds to the point of optimal operation. However, it will be noted that variations of 1 or 2 nanometers of wavelength are in any case not serious for an LED comprising a spectrum having a full width at half maximum of around ten nanometers, in particular when an optical assembly 6 is used comprising a prism 51 (second embodiment described hereinafter) or an optical system 25 used off-axis and having a lateral chromatic aberration (first embodiment described hereinafter) that does not select a reduced portion of this spectrum but transmits the entire spectrum of each light beam emitted by each source and passing through this optical assembly 6.

The housing generally comprises two metal pins that are connected to the support 2 respectively at an anode and at a cathode. It is possible to have:
a single light-emitting diode or “LED chip” per housing (“single chip” case). In this case, each fixing of a source on the support 2 typically comprises fixing the source directly into its housing by soldering (typically SMD soldering) of the housing onto the support 2. This case has the drawback of requiring a space between two sources that is greater than the dimension of the chips, because it is at least equal to the dimension of the housings.
Several light-emitting diodes or “LED chips” per housing (“multi-core” case). In this preferred case that will be described in greater detail hereinafter, each fixing of a source on the support 2 typically comprises fixing the source to the support 2 using glue. Once several (preferably all) the sources have been fixed onto the support, they are encapsulated in a single housing. This case is clearly preferred with respect to the previous case, because it makes it possible to bring the sources close together, i.e. to work with “narrower” chromatic dispersions in order to obtain a more compact emitter.

Each source (“LED chip”) has a planar, light-emitting surface (preferably lambertian) extending parallel to a plane (and is arranged in order to emit its beam preferably in a mean direction perpendicular to this plane), so that the thickness of this source is defined perpendicularly to this plane and the diameter of this source is defined as the minimum diameter of a circle contained within this plane and able to surround this source. The diameter of each source is preferably less than 1 millimetre, more preferentially less than 300 micrometres.

By “position” Xᵢ of a source Sᵢ, is meant, quite naturally for a person skilled in the art, the position of a fixed reference point for all the sources. This is preferably the position of the centre (or barycentre) of the part (or of the surface viewed from above) that generates light for each source or of the position of the upper left corner of each source, etc. This position is defined with respect to an origin X=0, arbitrarily defined. Sources will be discussed hereinafter that are in the shape of a rectangle, rhombus or square, and the position of each source will be considered to be the position of the centre of the rectangle, rhombus or square formed by each source.

Similarly, when different sources are considered that are aligned, fixed, distributed, etc. on different axes (13, 14, 15, and/or 40), reference is made to the alignment, fixing, distribution, etc. of this fixed reference point (centre, barycentre, corner, angle, etc.) of each source on these different axes (13, 14, 15, and/or 40).

A description will be given hereinafter of two embodiments of the method according to the invention for fabricating a light emitter 1 according to the invention, this light emitter 1 comprising the different, separate light sources Sᵢ (i an integer, i=1 to N) previously described and a planar support 2 common to all the sources. A first embodiment will be a fabricating method comprising measurements of the positions of the sources. A second embodiment will be a fabricating method comprising calculations of the positions of the sources. In these two embodiments, the fabricating method according to the invention comprises:
for each source Sᵢ, a determination (by measurement or by calculation) of a position Xᵢ of this source Sᵢ along a fixing direction 3, as a function of optical properties of a spectral multiplexer 4 planned to be associated with this emitter 1, of the working wavelength λᵢ of this source and of a placement 5 of the emitter 1 with respect to the multiplexer 4, the spectral multiplexer 4 comprising an optical assembly 6 having chromatic dispersion properties; the positions X₁ to X_{N} of the sources S₁ to S_{N} are determined so that, for this placement 5 of the emitter and for these positions X₁ to X_{N} of the sources S₁ to S_{N}, the optical assembly 6 is arranged in order to bring the light beams of the sources S₁ to S_{N} spatially closer together by means of its chromatic dispersion properties, so that the multiplexer 4 spatially superimposes (at least partially, preferably completely) said light beams into a multiplexed light beam 26,
fixing, along the fixing direction 3, each source S₁ to S_{N} onto the support 2 at its previously determined position X₁ to X_{N}, so that the sources S₁ to S_{N} are distributed along the fixing direction 3 (preferably in order of increasing working wavelength λ₁ to λ_{N}, the sources S₁ to S_{N} are thus preferably ranked by increasing order of chromaticity) according to the law or the properties of chromatic dispersion of the spectral multiplexer 4.

The determination step is implemented by technical means (measurement means, typically a detector and an optional filter, or calculation means).

The emitter 1 thus obtained is arranged so that, once associated with the multiplexer 4, the multiplexer 4 implements spectral multiplexing of the beams emitted by the sources S₁ to S_{N}. By “spectral multiplexing” is meant the spatial combination of several light beams, each contributing to the final spectral composition of a light beam 26 having parallel rays, called a “collimated” light beam 26. The multiplexed light beam 26 is thus a polychromatic light beam, since it comprises several mixed wavelengths λ₁ to λ_{N}.

The term “chromatic dispersion” according to the invention includes the chromatic aberrations.

A chromatic aberration of an optical assembly 6 (comprising or consisting of for example an optical system 25 or a prism 51 such as described hereinafter) is a variation of the position of the focal point of an incident light beam collimated on this optical assembly 6 then passing through this optical assembly 6, as a function of the wavelength of this light beam.

A lateral chromatic aberration of an optical assembly 6 (comprising or consisting of for example an optical system 25 such as described hereinafter) is a variation of the lateral position (i.e. perpendicularly to the optical axis A1 of the optical system 25) of the focal point of an incident light beam collimated on this optical assembly 6 then passing through this optical assembly 6, as a function of the wavelength of this light beam.

The propagation of a light beam emitted by each light source S₁ to S_{N} takes place in free space from said source to the optical assembly 6. “Free space” denotes any spatial medium of the signal pathway: air, inter-sidereal space, vacuum, etc, as opposed to a material transport medium, such as optical fibre or wired or coaxial transmission lines. Thus there is no coupling between the light beam emitted by a light source and a waveguide. There is no coupling known as “fibre-to-LED” such as may exist in the prior art. According to the invention, energy loss is thus minimal. The light beams are effectively mixed, and the intensity of the superimposed beam 26 is high. Moreover, this feature offers greater freedom of positioning of the light sources S₁ to S_{N} which reduces the cost of production according to the invention and enables mass production. Indeed, a coupling action between an optical fibre and a source for each of the sources is not required.

There will now be described, with reference to FIGS. 2 and 3, a first embodiment of a fabricating method according to the invention for fabricating a first embodiment of emitter 1 according to the invention.

In the first embodiment of emitter 1 according to the invention, the optical assembly 6 comprises at least one optical system 25 used off-axis and having a lateral chromatic aberration. This lateral chromatic aberration forms the chromatic dispersion property according to the invention.

The off-axis use accentuates, or even causes the appearance of, lateral spatial dispersion of the wavelengths. This can also be referred to as chromaticism of apparent magnitude.

The cost of such an optical system 25 is generally low because, intrinsically, any optical system used off-axis has lateral chromatic aberration, if it is not specifically corrected for this aberration by means of solutions known in optical design.

The light sources S₁ to S_{N} can be placed respectively at the foci of the optical system 25 corresponding to the wavelengths λ₁ to λ_{N}, so that their light beams are multiplexed at the output of the optical system 25.

The optical system 25 is said to be “used off-axis”, i.e. off its optical axis A1. In other words, an incident light beam, convergent at the object focus of the optical system, does not leave this optical system parallel to the optical axis A1 of said system. Thus, the foci of the optical system 25 corresponding to different wavelengths λ₁ to λ_{N} are sufficiently separated to be able to place the corresponding light sources S₁ to S_{N} at the site of these foci. In this way, the spectral multiplexing is precisely and automatically carried out by the aberrant optical system 25 used off-axis.

In this first embodiment of a fabricating method according to the invention, the step of determining the position of each source S₁ to S_{N} is carried out by a measurement.

The multiplexer 4 consists of the optical assembly 6.

The optical assembly 6 comprises (and even consists of) the off-axis optical system 25, i.e. in this example a thick biconcave lens 25 having an optical axis A1 the chromatic aberrations of which are used. The lens 25 has foci F₁ to F_{N} corresponding to the wavelengths λ₁ to λ_{N}. Due to the lateral chromatic aberration, these foci are different and separated, aligned along a straight line secant with the optical axis A1 of the lens 25.

The optical assembly 6 thus comprises an optical system (the lens 25 in this particular case) having a lateral chromatic aberration, the determined positions of the sources S₁ to S_{N} corresponding to an off-axis use of the optical system.

A detector 8 is used which has the same shape (here, planar) as the support 2. The detector 8 is arranged in order to detect a light beam focused thereon, and to determine a position of the focal point of this beam on the detection surface of this detector 8.

The detector 8 is typically an array detector (CCD (“Charge-Coupled Device”) camera or PDA (“Photo Diode Array”) detector or PMT (“Photo Multiplier Tube”) array or not (for example a PSD (for “Position Sensitive Detector”) diode.

The placement 5 of the emitter 1 with respect to the multiplexer 4, considered for determining the positions of the sources S₁ to S_{N} corresponds to a distance 7 between:

the apex of the concave surface 9 of the lens 25 oriented towards the support 2, and

the support 2 this support 2 being planar and positioned perpendicularly to the axis A1 of the lens 25.

### Measurement

In order to measure the position Xᵢ, along the fixing direction 3, of each source Sᵢ, the detector 8 is positioned at this placement 5 with respect to the multiplexer 4, i.e. in this example:

at the distance 7 previously considered, but this time between the apex of the concave face 9 of the lens 25 oriented towards the detector 8 and the detector 8, since the detector 8 replaces the support 2, and
perpendicularly to the axis A1 of the lens 25.

Finally, the other face 10 of the lens 25 is then illuminated by a collimated beam 27 of white light, corresponding to a use off-axis A1 of the lens 25.

Furthermore:
either at a position 18b between the detector 8 and the multiplexer 4,
or at a position 18a before the lens 25, i.e. in the collimated beam 27 of white light, the following are also provided: a very selective filter 18 (pass-band filter, full width at half maximum of 10 nm) allowing the working wavelength λᵢ of this source to pass (typically allowing at least 90% of the intensity of this working wavelength λᵢ, to pass) but blocking the working wavelengths of the other sources (typically blocking at least 90% of the intensity of these wavelengths, preferably blocking at least 99.9% of the intensity of these wavelengths).

Thus the position Xᵢ of the source Sᵢ is determined as the position of the focal point detected by the detector 8.

This procedure is carried out for each source, changing the filter 18 for each source.

The position 18a is very clearly preferred. In fact, the filter 18 is generally optimized and operates best at a given incidence (normal incidence in the case of FIG. 2), and at the position 18a there is no variation of incidence of the different wavelengths on the filter 18, while at the position 18b the different wavelengths have different incidences on the filter 18.

In a variant, the filter 18 can be dispensed with by replacing the while beam 27 with a monochromatic beam 27 at the working wavelength λᵢ of the source Sᵢ for which it is sought to determine the position Xᵢ, and by thus changing the monochromatic wavelength of the beam 27 for each source Sᵢ.

There will now be described, with reference to FIGS. 4 to 9, a second embodiment of the fabricating method according to the invention for fabricating a second embodiment of the emitter according to the invention.

In this second embodiment of the fabricating method according to the invention, the step of determining the position of each source S₁ to S_{N} is carried out by a calculation.

In this second embodiment of emitter 1 according to the invention, the optical assembly 6 comprises an achromatic doublet 55 and a prism 51 the chromatic dispersion properties (more precisely the chromatic aberration properties) of which are used.

This chromatic aberration forms the chromatic dispersion property according to the invention in this embodiment.

### Calculation

In order to determine the position of each of the sources S₁ to S_{N}, it is necessary to investigate the response of the multiplexer in the “reverse direction of use”, i.e. to investigate the chromatic dispersion of a white collimated beam.

In the optical assembly 6:

the prism 51 converts a collimated white beam 27 into a multitude of collimated monochromatic beams 28 the directions of which depend on their wavelengths, and

the doublet 55 focuses the collimated beams 28 in its focal plane as a function of their direction (but not of their wavelength).

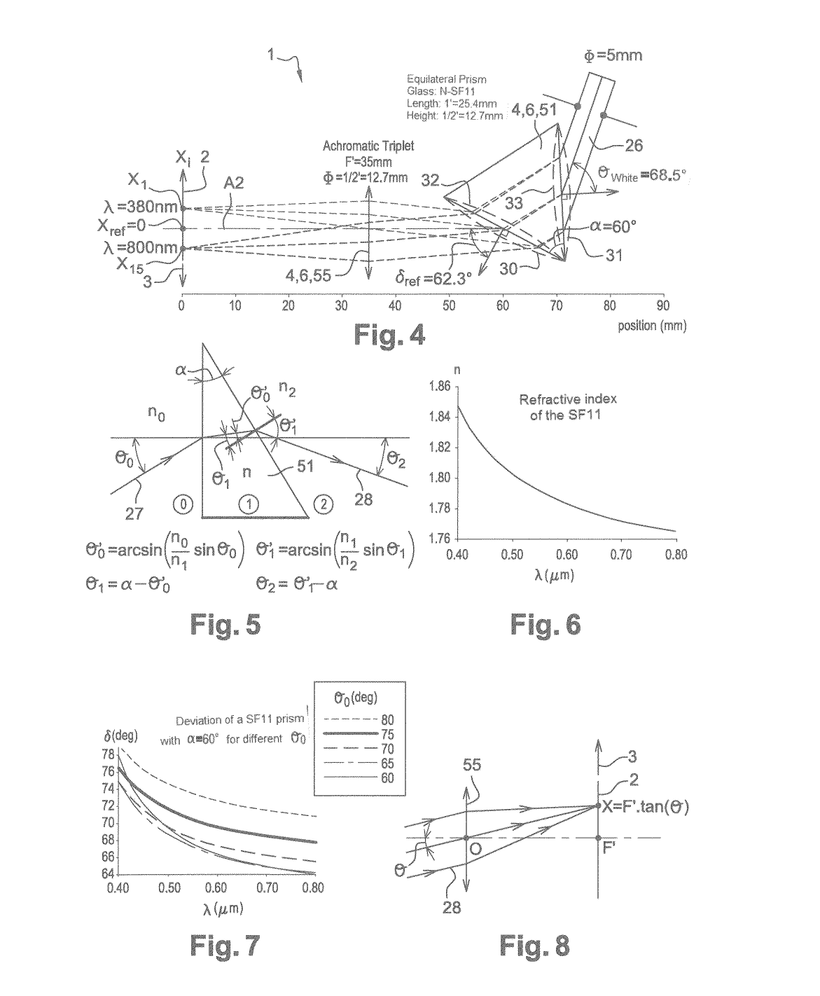

As shown in FIG. 5, for the prism 51, if n₀=n₂=1 (with n₀ and n₂ the outside optical indices of the prism 51 at each of its sides) thus the value of the deviation δ of a light ray is:

$$δ = {θ}_{0} + {θ}_{2} = {θ}_{0} + arcsin ( n sin [ α - arcsin ( \frac{1}{n} sin {θ}_{0} ) ] ) - α$$

where:

θ₀ is the angle of incidence of the ray

n is the optical index of the prism 51 (function of the wavelength of the ray λ); for example, FIG. 6 shows the value of n as a function of the wavelength λᵢ in the case of a SF11 glass prism 51.

α is the angle at the apex of the prism.

FIG. 7 gives different examples of deviation δ as a function of the wavelength λ and of θ₀ for α=60° (the prism 51 typically has a profile in the shape of an equilateral triangle, as this is a standard component and therefore inexpensive).

With reference to FIG. 8, the achromatic doublet 55 conjugates a collimated beam 28 (point at infinity) to a point of its focal plane according to the relationship:

X=F′·tan(θ)

### Where:

F′ is the focal length of the doublet 55

X is the height in the focal plane

θ is the angle of the collimated beam

Unlike a simple lens, the focal length of the achromatic doublet 55 is quasi-independent of λ. In order to reduce the focal length and/or increase the aperture a triplet may be preferred.

Thus, the position Xᵢ(λᵢ) of the source Sᵢ of working wavelength λᵢ (with i an integer i=1 to N) is determined by calculating it according to the formula:

$${X}_{i} ( {λ}_{i} ) = {F}^{′} tan ⌊ δ ( {λ}_{i} ) - δ ( {λ}_{ref} ) ⌋$$

$$with$$

$$δ ( {λ}_{i} ) = {θ}_{0} + arcsin ( n ( {λ}_{i} ) sin [ α - arcsin ( \frac{sin {θ}_{0}}{n ( {λ}_{i} )} ) ] ) - α ,$$

and λ_{ref} is the wavelength for which the origin of positions (X(λ_{ref})=0) is arbitrarily set.

This step of determination by calculation is implemented by technical means, more precisely by calculation means. The calculation means typically comprise a processor, typically an analogue and/or digital electronic circuit, and/or a microprocessor and/or a computer central processing unit.

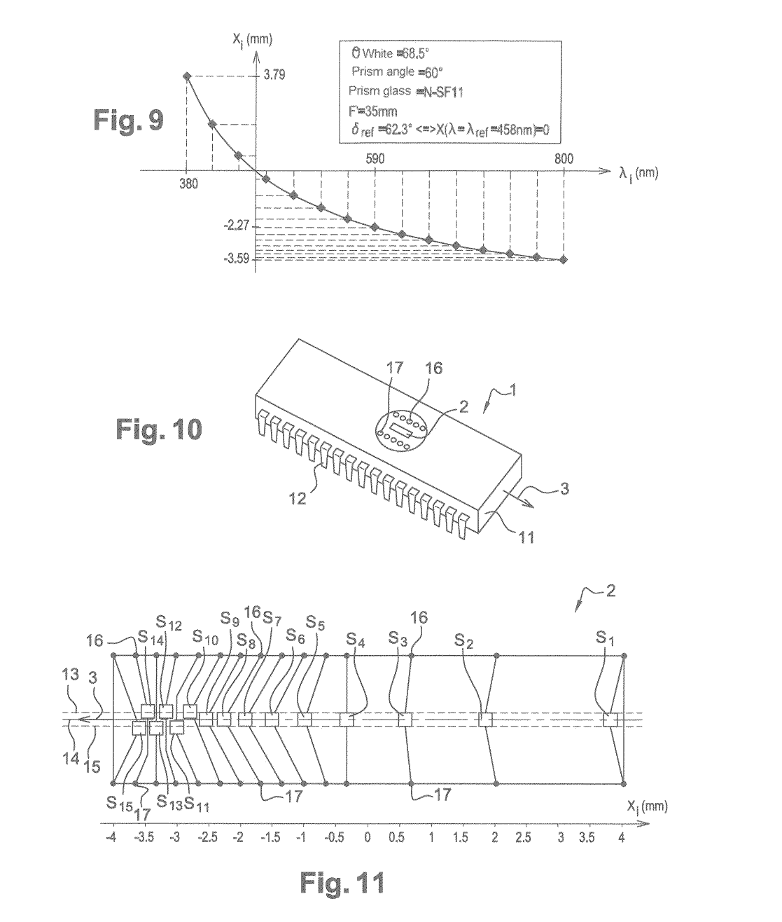

FIG. 9 shows an example for an SF11 glass prism, for α=60°, for θ₀=θWhite=68.5°, for F′=35 mm and for δ_{ref}=δ(λ_{ref})=62.3°.

This step of determination by calculation could be completed by an optical design step: radiometric optimization. This calculation step consists of simulating the source+optical system assembly in the sense of actual operation so as to optimize the collimated white exit beam by slight modifications of the position of the sources as well as of the radii of curvature, thicknesses and/or positions of the optics of the multiplexer.

The table below shows an example for an SF11 glass prism, for α=60°, for θ₀=θWhite=68.5°, for F′=35 mm, for δ_{ref}=δ(λ_{ref})=62.3° and for N=15.

| | Number of the source i= | | | | | | | |
|---|---|---|---|---|---|---|---|---|
| | 1 | 2 | 3 | 4 | 5 | 6 | 7 | 8 |
| Working wavelength | 380 | 410 | 440 | 470 | 500 | 530 | 560 | 590 |
| λᵢ of this source (in | | | | | | | | |
| nm) | | | | | | | | |
| Position Xᵢ of this | 3.79 | 1.84 | 0.57 | −0.32 | −0.99 | −1.52 | −1.93 | −2.27 |
| source along the | | | | | | | | |
| direction 3 (in mm) | | | | | | | | |
| Position Yᵢ of this | 0 | 0 | 0 | 0 | 0 | 0 | 0 | 0 |
| source | | | | | | | | |
| perpendicularly to | | | | | | | | |
| the direction 3 (in | | | | | | | | |
| mm) | | | | | | | | |

| | Number of the source i= | | | | | | |
|---|---|---|---|---|---|---|---|
| | 9 | 10 | 11 | 12 | 13 | 14 | 15 |
| Working wavelength | 620 | 650 | 680 | 710 | 740 | 770 | 800 |
| λᵢ of this source (in | | | | | | | |
| nm) | | | | | | | |
| Position Xᵢ of this | −2.56 | −2.8 | −3 | −3.18 | −3.33 | −3.47 | −3.59 |
| source along the | | | | | | | |
| direction 3 (in mm) | | | | | | | |
| Position Yᵢ of this | 0 | 0.125 | −0.125 | 0.125 | −0.125 | 0.125 | −0.125 |
| source | | | | | | | |
| perpendicularly to | | | | | | | |
| the direction 3 (in | | | | | | | |
| mm) | | | | | | | |

There will now be described, with reference to FIGS. 3, 4, 10 and 11, the steps of the first or the second embodiment of a fabricating method according to the invention following the step of determining the position Xᵢ of each source Sᵢ. As an example, the case will be considered of the fifteen positions X₁ to X₁₅, summarized in the above table, which correspond to the positions determined by calculation but which can also correspond to values determined by measurements according to the first embodiment of the fabricating method according to the invention.

After having determined the positions of the sources S₁ to S_{N}, the fabricating method according to the invention shown comprises fixing each source S₁ to S_{N}, along the fixing direction 3, onto the support 2 at its previously determined position X₁ to X_{N}, so that the sources S₁ to S_{N} are distributed along the fixing direction 3 in order of increasing working wavelength λ₁ to λ_{N} and according to the law or the properties of chromatic dispersion of the spectral multiplexer.

It is noted that according to the invention it is not simply sought to put the sources S₁ to S_{N} closer to one another: the spacing between the sources S₁ to S_{N} must comply with the law of chromatic dispersion of the optical assembly 6 for which it is designed.

The support 2 is a planar surface firmly fixed to an electronic chip 11 equipped with connecting pins 12 arranged in order to fix the chip 11 onto an electronic circuit board and to make it possible to supply each source S₁ to S_{N} independently with electricity.

The support 2 is covered with glue before placing each source S₁ to S_{N}. According to the chosen method of electrical supply, either conductive glue or insulating glue is used.

In order to fix each source Sᵢ onto the support 2, this source is held by a suction tip, and the source Sᵢ is placed on the support 2 (more precisely in contact with the glue) by the suction tip, at its previously determined position Xᵢ. During placement, the projection of the tip over the plane of the support 2 remains fixed, and the support 2 is mounted on a piezoelectric displacement stage and is mobile so as to place the source Sᵢ at its correct, previously determined position Xᵢ.

An additional baking step is implemented in order to set the glue permanently.

With reference to FIG. 11, it is advisable for the fixing to comprise fixing the sources S₁ to S_{N} on at least two (preferably at least three, preferably three) parallel fixing axes 13, 14, 15 extending along the fixing direction 3. Thus, the sources do not necessarily have the same coordinates Y₁ to Y_{N} perpendicular to the direction 3.

Thus, the space requirement of the sources S₁ to S_{N} is reduced by “superimposing” them on the axis X by means of an offset in the Y direction.

It is noted that the emitter 1 according to the invention, obtained by a fabricating method according to the invention, is particularly appropriate in that it comprises sources S₁ to S_{N} on at least two (preferably at least three, preferably three) parallel fixing axes 13, 14, 15 extending along the fixing direction 3.

Among the sources S₁ to S_{N}, there are pairs of two sources (for example S₁₀ and S₁₁, or S₁₁ and S₁₂, or S₁₂ and S₁₃, or S₁₃ and S₁₄, or S₁₄ and S₁₅) having adjacent positions along the fixing direction 3 (i.e. without a third source having an intermediate position along the fixing direction 3 comprised between the positions of these two sources along the fixing direction 3) but which are not fixed on the same fixing axis 13, 14, 15.

It is noted that the sources S₁ to S_{N} comprise two sets:

a first set of sources S1 to S9, and

a second set of sources S10 to S15 the working wavelengths λ₁₀ to λ₁₅ of which are greater than all the working wavelengths λ₁ to λ₉ of the sources of the first set.

All the sources of the second set belong to a pair of two sources (for example S₀ and S₁₁, or S₁₁ and S₁₂, or S₁₂ and S₁₃, or S₁₃ and S₁₄, or S₁₄ and S₁₅) having adjacent positions along the fixing direction 3 but which are not fixed on the same fixing axis 13, 14, 15.

Each source is linked to an anode 16 and to a cathode 17 (typically by gold wire bonding).

As has just been described, the emitter 1 comprises the support 2 and the sources S₁ to S_{N}.

The emitter 1 can moreover comprise the chip 11 firmly fixed to the support 2.

The emitter can moreover comprise control electronics (not shown), arranged in order to control each source independently of the other sources. Typically, this control electronics is an electronic circuit board (printed circuit) on which the chip 11 is fixed.

Moreover, the fabricating method according to the invention can comprise, as shown in FIGS. 3 and 4, after the fixing of each source S₁ to S_{N}, associating the emitter 1 with the spectral multiplexer 4 considered in order to determine the position X₁ to X_{N} of each source S₁ to S_{N}. By this association, a method is thus proposed for fabricating an assembly comprising the emitter 1 and the multiplexer. The multiplexer 4 is associated with the emitter 1 by placing the emitter 1 at its placement 5 considered during the determination of the positions X₁ to X_{N} of sources S₁ to S_{N}. The emitter 1 plus multiplexer 4 assembly can form a part of an absorption spectrometer, the spectral multiplexer 4 being capable of mixing the light beams of the sources S₁ to S_{N} in order to form a multiplexed (or superimposed) light beam 26 intended to illuminate a specimen to be analyzed.

For example, in the case of the first embodiment of an emitter according to the invention shown in FIG. 3, the support 2 is placed:

at the distance 7, with respect to the lens 25, considered for determining the position X₁ to X_{N} of each source S₁ to S_{N}

with the inclination of the support 2 (for example perpendicular), with respect to the axis A1, considered for determining the position X₁ to X_{N} of each source S₁ to S_{N},

assuming that the intersection of the support 2 and the axis A1 corresponds to a position reference value X_{ref} (for example X_{ref}=0) considered for determining the position X₁ to X_{N} of each source S₁ to S_{N}.

Similarly, in the case of the second embodiment of an emitter according to the invention shown in FIG. 4, the support 2 is placed:

at the focal length F′, with respect to the doublet 55, considered for determining the position X₁ to X_{N} of each source S₁ to S_{N}

with the inclination of the support 2 (a priori perpendicular), with respect to the optical axis A2 of the doublet 55, considered for determining the position X₁ to X_{N} of each source S₁ to S_{N},

assuming that the intersection of the support 2 and the optical axis of the doublet 55 corresponds to a position reference value X_{ref} (for example X_{ref}=0 in the case of the fifteen values calculated in the preceding table) considered for determining the position X₁ to X_{N} of each source S₁ to S_{N}.

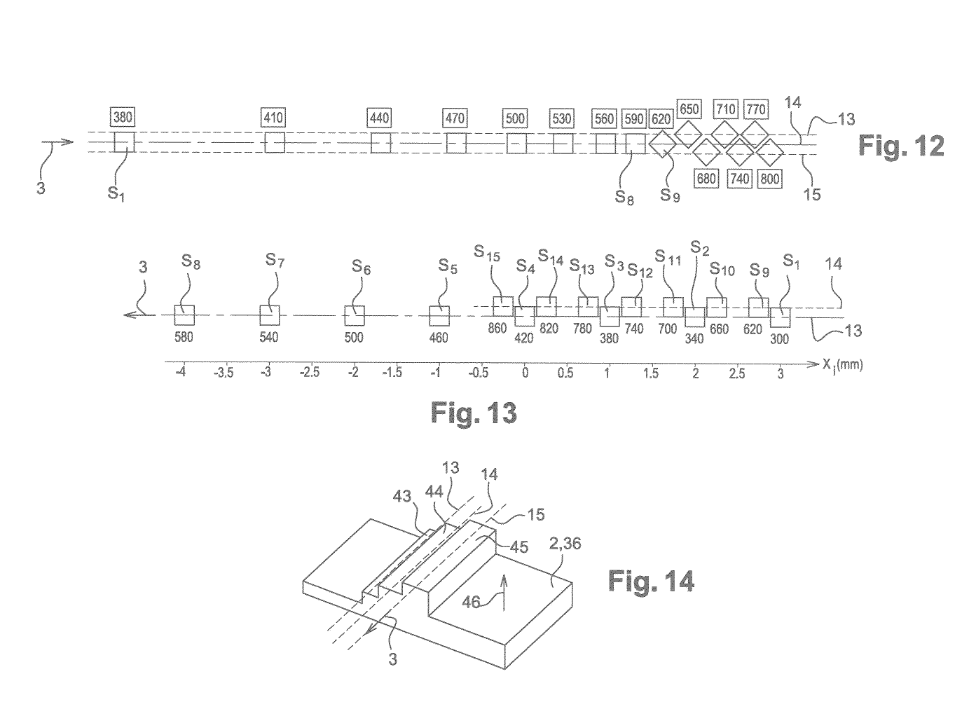

With reference to FIG. 12 which is a variant that will be described only with regard to its differences with respect to the case of FIG. 11 (with preferably the same optical assembly 6 as in the case of FIG. 11), each source S₁ to S_{N} has the shape of a quadrilateral, square or rhombus. For at least a part of the sources (S₉ to S₁₅) one after another along the fixing direction 3, each source has one of the diagonals of its quadrilateral shape aligned on one of the fixing axes 13, 14 or 15. This makes it possible to bring the axes closer together, i.e. to work with “narrower” chromatic dispersions, so as to obtain a more compact emitter and thus more effective collection.

With reference to FIG. 13 which is a variant that will be described only with regard to its differences with respect to the case of FIG. 11, the sources S₁ to S_{N} (N=15) are distributed on different fixing axes 13, 14 so that:

the first fixing axis 13 corresponds to a first working wavelength range (300 to 580 nm) of the sources S₁ to S₈ distributed on this axis 13, and

the second fixing axis 14 corresponds to a second working wavelength range (620 to 860 nm) of the sources S₉ to S₁₅ distributed on this axis 14, so that there is no intersection between these two working wavelength ranges, but that the sources of the first working wavelength range (300 to 580 nm) and the sources of the second working wavelength range (620 to 860 nm) are situated one after another (perpendicularly to the direction 3). Thus, all the sources S₁ to S₁₅ considered as a whole are not distributed along the fixing direction 3 in order of increasing working wavelength λ₁ to λ₁₅.

It is therefore noted that:
for the fixing axis 13 considered individually, each source S₁ to S₈ of this axis 13 is fixed along the fixing direction 3 on the support 2 at its position respectively X₁ to X₈ determined according to the previously described first or second embodiment of the method according to the invention (measurement or calculation) so that the sources S₁ to S₈ of this axis 13 are distributed along the fixing direction 3 in order of increasing working wavelength λ₁ to λ₈, and
for the fixing axis 14 considered individually, each source S₉ to S₁₅ of this axis 14 is fixed along the fixing direction 3 on the support 2 at its position respectively X₉ to X₁₅ determined according to the previously described first or second embodiment of the method according to the invention (measurement or calculation) so that the sources S₉ to S₁₅ of this axis 14 are distributed along the fixing direction 3 in order of increasing working wavelength λ₉ to λ₁₅.

On the other hand, unlike the case in FIGS. 11 and 12, it is noted that all the sources S₁ to S₁₅ considered as a whole are not distributed along the fixing direction 3 in order of increasing working wavelength λ₁ to λ₁₅.

The case of FIG. 13 corresponds preferably to the case of FIG. 4 for which the prism 51 is replaced by a diffraction grating. Thus in this case the multiplexer and the optical assembly comprise (preferably consist of) the same diffraction grating. The first fixing axis 13 uses the first-order chromatic dispersion properties of the diffraction grating and the second fixing axis 14 uses the second-order chromatic dispersion properties of the diffraction grating. It is noted in FIG. 13 that the dispersion of a diffraction grating is linear.

It is possible that all of the sources taken as a whole are not distributed along the fixing direction 3 in order of increasing working wavelength. This is the case in particular, with reference to FIG. 17, when the optical assembly 6 has chromatic dispersion properties comprising chromatic folding in the plane of the support 2, as for an apochromatic objective. In the case of FIG. 17, in the light of the different parallel axes 13, 14, 15 and 40, it is noted that:
for the fixing axis 40 considered individually, each source S₁ to S₃ of this axis 40 is fixed along the fixing direction 3 on the support 2 at its position respectively X₁ to X₃ determined according to the previously described first or second embodiment of the method according to the invention (measurement or calculation) so that the sources S₁ to S₃ of this axis 40 are distributed along the fixing direction 3 by decreasing order of working wavelength λ₁ to λ₃.
for the fixing axis 13 considered individually, each source S₁₀, S₁₂ and S₁₄ of this axis 13 is fixed along the fixing direction 3 on the support 2 at its position respectively X₁₀, X₁₂ and X₁₄, determined according to the previously described first or second embodiment of the method according to the invention (measurement or calculation) so that the sources S₁₀, S₁₂ and S₁₄ of this axis 13 are distributed along the fixing direction 3 in order of increasing working wavelength λ₁₀, λ₁₂ and λ₁₄,
for the fixing axis 14 considered individually, each source S₄ to S₉ of this axis 14 is fixed along the fixing direction 3 on the support 2 at its position respectively X₄ to X₉ determined according to the previously described first or second embodiment of the method according to the invention (measurement or calculation) so that the sources S₄ to S₉ of this axis 14 are distributed along the fixing direction 3 in order of increasing working wavelength λ₄ to λ₉, and
for the fixing axis 15 considered individually, each source S₁₁, S₁₃ and S₁₅ of this axis 15 is fixed along the fixing direction 3 on the support 2 at its position respectively X₁₁, X₁₃ and X₁₅, determined according to the previously described first or second embodiment of the method according to the invention (measurement or calculation) so that the sources S₁₁, S₁₃ and S₁₅ of this axis 15 are distributed along the fixing direction 3 in order of increasing working wavelength λ₁₁, λ₁₃ and λ₁₅,

Unlike the case in FIGS. 11 and 12, it is noted that all the sources S₁ to S₁₅ considered as a whole are not distributed along the fixing direction 3 in increasing order of working wavelength λ₁ to λ₁₅.

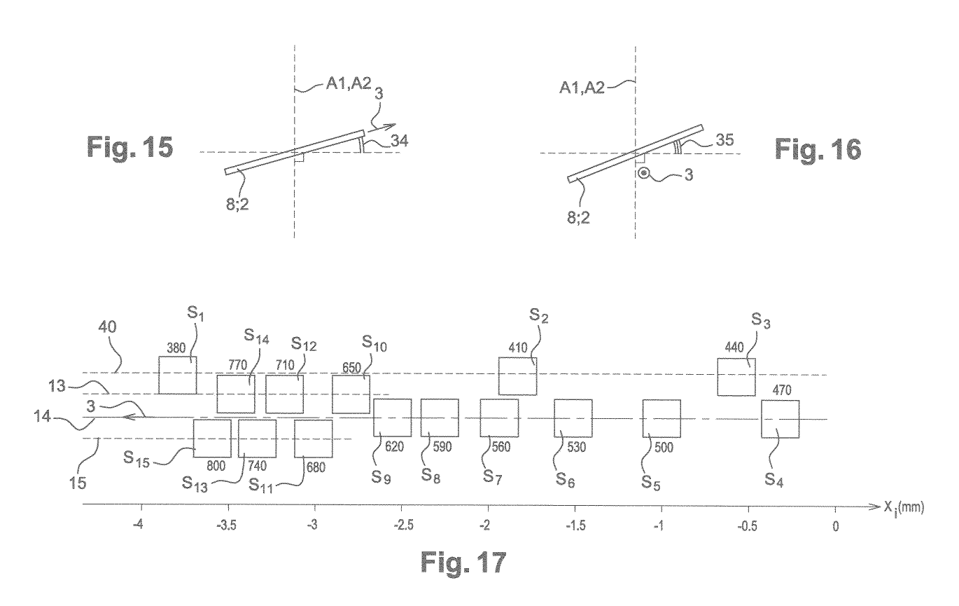

With reference to FIGS. 14 to 16, it will be noted that for all the embodiments described:
the support 2 (just like the detector 8 in the case of a measurement) can, with reference to FIG. 15, be inclined at an angle 34 (about an axis perpendicular to the fixing direction 3) and/or
the support 2 (just like the detector 8 in the case of a measurement) can, with reference to FIG. 16, be inclined at an angle 35 (about an axis parallel to the fixing direction 3) with respect to the optical axis A1 or A2, and/or
with reference to FIG. 14, the planar support 2 can be equipped with relief patterns (cavities, bumps, grooves and/or steps) so that when the sources S1 to SN are fixed onto the support 2, some sources are fixed onto these patterns and are raised with respect to other sources along a normal 46 to the plane 36 of the support 2,

so as to compensate for the longitudinal chromatic aberrations of the spectral multiplexer. It is particularly appropriate to have as patterns a step 43, 44, 45 for each fixing axis 13, 14, 15, each step 43, 44, 45 having a different elevation from the other steps along a normal 46 to the plane 36 of the support 2. In the case of FIG. 13 (the optical assembly 6 preferably being a diffraction grating), it is particularly appropriate to have a step 43, 44 for each working wavelength range, i.e. for each fixing axis 13, 14, each step 43, 44 having a different elevation from the other steps along the normal 46 to the plane 36 of the support 2.

Of course, the invention is not limited to the examples which have just been described and numerous adjustments can be made to these examples without exceeding the scope of the invention.

Of course, the various characteristics, forms, variants and embodiments of the invention can be combined together in various combinations insofar as they are not incompatible or mutually exclusive. In particular, all the previously described variants and embodiments can be combined together.

For example, it is possible to use the first embodiment of the method according to the invention (measurement) for fabricating the second embodiment of an emitter according to the invention.

Similarly, it is possible to use the second embodiment of the method according to the invention (calculation) for fabricating the first embodiment of an emitter according to the invention.

Moreover, the second embodiment of the method according to the invention (calculation) can be based on a calculation in which the calculation steps, implemented by technical means, are based on a theoretical model or on a digital simulation model.

Finally, the first or the second embodiment of the method according to the invention (measurement or calculation) can be used to fabricate numerous other example embodiments of an emitter according to the invention. It will be noted for example that the prism 51 can be replaced or combined with a diffraction grating, the chromatic dispersion properties of which can also be used.

For example, the first or the second embodiment of the method according to the invention (measurement or calculation) can be used to fabricate a variant of the second embodiment of an emitter according to the invention (FIG. 4), in which:
the prism 51 has a domed (preferably concave) entry face 30 of the light beams, and/or a domed (preferably concave) exit face 31 of the light beams, or
the prism 51 is replaced by two lenses, including a first lens (faces 30 and 32) positioned on the entry face of the light beams of the prism 51, and a second lens (face 31 and 33) positioned on the exit face of the light beams of the prism 51, i.e. by two lenses (preferably biconcave) the optical axes of which intersect between these two lenses.

1-20. (canceled)

21. Method for fabricating a light emitter (1) comprising several separate light sources (S₁, Sᵢ, S_{N}) and a support (2) common to all the sources, each source (S₁, Sᵢ, S_{N}) being arranged in order to emit a light beam at a wavelength called working wavelength (λ₁, λᵢ, λ_{N}), each source being a light-emitting diode, each source having a working wavelength different from the working wavelength of the other sources, characterized in that it comprises:
for each source, determining a position (X₁, Xᵢ, X_{N}) of this source along a fixing direction (3), as a function of optical properties of a spectral multiplexer (4) planned to be associated with this emitter, as a function of the working wavelength of this source and as a function of a placement (5) of the emitter with respect to the multiplexer, the spectral multiplexer comprising an optical assembly (6) comprising a lens and/or a prism and having chromatic aberration properties of the lens and/or of the prism; the positions of these sources (X₁, Xᵢ, X_{N}) being determined so that, for this placement (5) of the emitter and for these positions of the sources, the optical assembly (6) is arranged in order to bring the light beams of the sources spatially closer together by means of its chromatic aberration properties so that the multiplexer (4) spatially superimposes said light beams,
fixing each source (S₁, Sᵢ, S_{N}), along the fixing direction (3), onto the support (2) at its previously determined position (X₁, Xᵢ, X_{N}).

22. Method according to claim 21, characterized in that the fixing comprises fixing the sources on at least two parallel fixing axes (13, 14, 15) extending along the fixing direction (3).

23. Method according to claim 22, characterized in that two sources having adjacent positions along the fixing direction are not fixed on the same fixing axis.

24. Method according to claim 22, characterized in that each source has a quadrilateral shape, preferably of a square or rhombus; and in that, for at least a portion of the sources one after another along the fixing direction, each source has one of the diagonals of its quadrilateral shape aligned on one of the fixing axes.

25. Method according to claim 22, characterized in that the sources are distributed on the different fixing axes (13, 14) so that each fixing axis corresponds to a working wavelength range of the sources distributed on this axis, so that there is no intersection between the working wavelength ranges of the different fixing axes.

26. Method according to claim 22, characterized in that, for each fixing axis (13, 14, 15) considered individually, each source (S₁, Sᵢ, S_{N}) of this axis is fixed on the support (2) along the fixing direction (3) at its previously determined position (X₁, Xᵢ, X_{N}), so that the sources of this axis are distributed along the fixing direction in order of increasing working wavelength (λ₁, λᵢ, λ_{N}).

27. Method according to claim 26, characterized in that all the sources taken as a whole are not distributed along the fixing direction in order of increasing working wavelength (λ₁, λᵢ, A_{N}).

28. Method according to claim 21, characterized in that for the fixing step, each source (S₁, Sᵢ, S_{N}) is fixed along the fixing direction (3) on the support (2) at its previously determined position (X₁, Xᵢ, X_{N}), so that all the sources considered as a whole are distributed along the fixing direction in order of increasing working wavelength (λᵢ, λᵢ, λ_{N}).

29. Method according to claim 21, characterized in that the optical assembly comprises an optical system (25) having a lateral chromatic aberration, the positions of the sources corresponding to an off-axis use of the optical system.

30. Method according to claim 21, characterized in that fixing each source comprises holding the source with a suction tip, and placing the source on the support by the suction tip.

31. Method according to claim 30, characterized in that the support is covered with glue before placing each source, and in that each source is placed on the glue.

32. Method according to claim 21, characterized in that the emitter (1) comprises an electronic controller of the sources, arranged in order to control each source independently of the other sources.

33. Method according to claim 21, characterized in that it comprises, after fixing, associating the emitter (1) with the multiplexer (4) at its placement (5) considered during the determination of the positions of the sources.

34. Method according to claim 21, characterized in that the support (2) is integral with an electronic chip (11) equipped with connecting pins (12) arranged in order to fix the chip onto an electronic circuit board.

35. Method according to claim 21, characterized in that the optical assembly (6) comprises a lens (25; 55) and/or a prism (51) and/or a diffraction grating.

36. Method according to claim 22, characterized in that the support (2) is equipped with relief patterns so that when the sources are fixed onto the support (2), some sources are fixed onto these patterns and are raised with respect to other sources so as to compensate for the longitudinal chromatic aberrations of the spectral multiplexer.

37. Method according to claim 36, characterized in that the patterns comprise a step (43, 44, 45) for each fixing axis (13, 14, 15), each step (43, 44, 45) having a different elevation from the other steps.

38. Method according to claim 21, characterized in that the support (2) is equipped with relief patterns so that when the sources are fixed onto the support (2), some sources are fixed onto these patterns and are raised with respect to other sources so as to compensate for the longitudinal chromatic aberrations of the spectral multiplexer.

39. Method according to claim 23, characterized in that each source has a quadrilateral shape, preferably of a square or rhombus; and in that, for at least a portion of the sources one after another along the fixing direction, each source has one of the diagonals of its quadrilateral shape aligned on one of the fixing axes.

40. Method according to claim 23, characterized in that the sources are distributed on the different fixing axes (13, 14) so that each fixing axis corresponds to a working wavelength range of the sources distributed on this axis, so that there is no intersection between the working wavelength ranges of the different fixing axes.
